(19) United States
(12) Patent Application Publication
(10) Pub. No.: US 2016/0372854 A1
(43) Pub. Date: Dec. 22, 2016

(54) PLUG CONNECTOR ASSEMBLY FOR ESTABLISHING AN ELECTRICAL PLUG CONNECTION

(71) Applicant: Robert Bosch GmbH, Stuttgart (DE)

(72) Inventors: Ulrich Schmatz, Besigheim (DE); Martin Saur, Salach (DE); Zhenyu Hu, Leonberg (DE); Wolfgang Pade, lllingen (DE); Rolf Wittmann, Ludwigsburg (DE)

(21) Appl. No.: 15/182,714

(22) Filed: Jun. 15, 2016

(30) Foreign Application Priority Data
Jun. 17, 2015 (DE) 102015211155.5

(51) Int. Cl. H01R 13/432

(52) U.S. Cl. CPC H01R 13/432

(57) ABSTRACT

A plug connector assembly for establishing an electrical plug connection, the plug connector assembly including a contact carrier and a contact. The contact is insertable into the contact carrier in a plug-in direction and extends along a longitudinal axis. It has a contact section and a connecting neck section. The contact section including a contact latching element, which includes a protrusion transverse to the longitudinal axis and is, in particular, immovable in relation to the contact section. The contact carrier includes a contact carrier housing having a chamber for receiving the contact section of the contact. The chamber includes a first inner wall generally in parallel to the plug-in direction, a contact carrier latching element, provided adjacent to the first inner wall generally transverse to the plug-in direction, which includes a contact carrier latching surface, and a second inner wall opposite the first inner wall.

### CROSS REFERENCE

The present application claims the benefit under 35 U.S.C. §119 of German Patent Application Ser. No. DE 102015211155.5 filed on Jun. 17, 2015, which is expressly incorporated herein by reference in its entirety.

### FIELD

The present invention relates to a plug connector assembly for establishing an electrical plug connection. The present invention also relates to a contact for insertion in a plug-in direction into a contact carrier of a plug connector assembly for establishing an electrical plug connection.

### BACKGROUND INFORMATION

In plug connector assemblies for establishing electrical plug connections, for example, in the automotive sector, contacts, once they are crimped, are usually mounted in a contact carrier manufactured from plastic. A contact is generally latched in place in the contact carrier either by an elastic element protruding as a latching lance from the contact, which engages in a corresponding recess on the contact carrier. Alternatively, an elastic element is provided in the contact carrier, which snaps into a corresponding recess on the contact. In this way, the contact is secured with a primary retention force against unplugging from the contact carrier.

A plug connector assembly of this type is described in German Patent Application Ser. No. DE 10 2012 203 990 A1.

### SUMMARY

The present invention is based on the finding that a significant challenge is involved in structurally designing the elastic element and the corresponding recess in order to achieve the desired primary retention forces. Thus, for example, the material thicknesses of miniaturized contacts are so minimal that it is difficult to apply the required primary retention force, without damaging or even destroying the elastic element fastened to the contact or the edges of the recess provided on the contact for latching in place an elastic element provided on the contact carrier. In order nevertheless to enable the contact to resist being unplugged from the contact carrier with a force corresponding to the primary retention force, it is frequently necessary to insert a separate secondary locking element into the plug connector assembly, which renders the plug connector assembly expensive and complex and complicates the fitting process.

On the other hand, the structural design of contacts, which have a material thickness greater than miniaturized contacts and are suited, generally, for absorbing the required primary retention force, is also problematic. Thus, when applying the primary retention force, for example, a free end of the elastic element of the contact or an edge of the recess on the contact may bury itself into the material of the contact carrier, due to its minimal contact surface and the resulting high linear pressure on the corresponding receiving surface of the contact carrier and, in that way, damage or even destroy the contact carrier.

Therefore, a need may exist for providing a plug connector assembly in a cost-effective and simple manner, in which a reliable latching of the contact in the contact carrier is ensured by a novel design, and in which at the same time the latching withstands the required primary retention force, without resulting in damage to the contact or the contact carrier.

This need may be met by example embodiments of the present invention.

According to a first aspect of the present invention, a plug connector assembly for establishing an electrical plug connection is provided, in which a latching surface is utilized between the contact and the contact carrier, which is significantly larger as compared to the related art. The latching surface of the contact in this case is not connected to the elastic element. This results in a considerably higher primary retention force with the same material thickness as compared to the related art. In addition, this lowers the risk of damage to the generally softer material of the contact carrier when applying a force for unplugging the contact from the contact carrier, as compared to the related art.

This is achieved in that the plug connector assembly for establishing an electrical plug connection includes a contact carrier and a contact. In this assembly, the contact is insertable in the contact carrier in a plug-in direction and extends along a longitudinal axis. The contact has a contact section and a connecting neck section. The contact section has a contact latching element, which has a protrusion transverse to the longitudinal axis in relation to the neck section. The contact latching element may be, in particular, immovable or rigid with respect to the contact section, in particular, immovably or rigidly designed in the sense of “non-resilient” or “not as an elastic element” (for example, in the form of a latching lance). It may have a surface facing in a direction opposite the plug-in direction, which effectuates the latching. The contact carrier includes a contact carrier housing with a chamber for receiving the contact section of the contact. The chamber in this case includes a first inner wall generally in parallel to the plug-in direction, a contact carrier latching element adjacent to the first inner wall designed generally transversely to the plug-in direction, which includes a contact carrier latching surface, as well as a second inner wall opposite the first inner wall. In this configuration, the contact latching element and the contact carrier latching surface are designed in such a way that the contact carrier latching element engages behind the contact latching element in a latched position of the contact inserted into the contact carrier. It is provided according to the present invention that at least one elastic element is provided in the plug connector assembly, which is designed to push the contact in the inserted state in the contact carrier away from the second inner wall transversely to the plug-in direction into the latched position and to hold it there. Thus, a translational movement of the contact transverse to the plug-in direction is caused by the elastic element.

According to a second aspect of the present invention, a contact is provided for insertion in a plug-in direction into a contact carrier of a plug connector assembly for establishing an electrical plug connection, which provides a latching surface of a contact latching element between the contact and the contact carrier, which is significantly larger compared to the related art, and in which the contact latching element is not connected to the elastic element. This results in a considerably higher primary retention force with the same material thickness as compared to the related art. In addition, this lowers the risk of damage to the generally softer material of the contact carrier when applying a force for unplugging the contact from the contact carrier, as compared to the related art.

This is achieved in that the contact for insertion in a plug-in direction into a contact carrier of a plug connector assembly for establishing an electrical plug connection includes a contact housing, which extends along a longitudinal axis. The contact housing has a contact section and a connecting neck section, the contact section including a contact latching element. This contact latching element may be, in particular, immovable or rigid with respect to the contact section, i.e., in other words, designed to be non-resilient or not as an elastic element. It may have a surface facing in a direction opposite the plug-in direction, which effectuates the latching. The contact latching element has a protrusion transverse to the longitudinal axis in relation to the neck section. The contact latching element in this case is designed in such a way that in a latched position of the contact inserted into the contact carrier, it may be engaged from behind in such a way that in this manner a removal of the contact from the contact carrier may be prevented. According to the present invention, it is provided that at least one elastic element is fastened on or in the contact housing, in particular, on or in the contact section of the contact housing, the at least one elastic element being designed to push the contact in the inserted state in the contact carrier transversely to the plug-in direction into the latched position and to hold it there. This may take place, in particular, in that the elastic element pushes the contact transversely to the plug-in direction into the latched position and holds it there. In other words, the contact is raised or moved translationally by the elastic element and in this way pushed into and held in the latched position. Thus, a translational movement of the contact transverse to the plug-in direction is caused by the elastic element.

In one refinement of the plug connector assembly or of the contact, it may be provided that in the latched position, the elastic element abuts a contact surface, in particular, on the second inner wall, the contact surface extending generally in parallel to the plug-in direction. In parallel is understood to also mean deviations from exact parallelism in the range of +/−10°, in particular +/−5°. In other words, the second inner wall and the elastic element on the potential contact surfaces of the elastic element are formed on the second inner wall in such a way that when unplugging the contact from the contact carrier, the elastic element is not latched in an undercut of the contact carrier. The second inner wall may preferably be designed without an undercut. Thus, the elastic element may slide along on the second inner wall, in particular, without jamming in the process.

In another refinement of the plug connector assembly or contact, it may be provided that the contact is formed as a contact box in the contact section, the contact box being designed to receive a mating contact pluggable in the plug connector assembly opposite the plug-in direction in an interior of the contact box. In other words, the contact is therefore designed as a socket contact, into which a mating contact is pluggable. The contact box has an independent function: the electrical contact of the plug connector assembly takes place between the contact and the mating contact. The neck section in this case forms the transition from the contact box in the contact section to a fastening section, in which, for example, a cable may be fastened. The contact carrier housing may be formed from an electrically insulating material and include, for example, plastic. The contact carrier housing may be designed in such a way that it provides merely a mechanical hold for the contact.

In one refinement of the plug connector assembly or of the contact, it may be provided that the elastic element and the contact latching element are designed in such a way that in the state of the contact in the latched position in the contact carrier, the elastic element absorbs at most 10% of the force component along the plug-in direction when the contact is acted upon by a force opposite the plug-in direction. Accordingly, the contact element absorbs at least 90%, in particular, at least 95%, of the axial forces along the plug-in direction.

As a result, the functions of the elastic element and of the contact latching element and the contact carrier latching surface are advantageously decoupled from one another, as compared to the related art, advantageously both in the case of the plug connector assembly according to the present invention, as well as the contact according to the present invention. In other words, the functions “latching” and “primary retention force” or the elements which effectuate these functions, are elements separate from one another and spatially separated from one another. The elastic element may be advantageously designed in such a way that it exhibits a sufficient spring force transverse to the plug-in direction and is designed merely to push the contact away from the second inner wall into the latched position and to hold it there, in particular, by a lifting relative to the second inner wall. In contrast, when attempting to unplug the contact from the contact carrier, the force acting counter to the plug-in direction is absorbed by the contact latching element and the contact carrier latching surface separated spatially and functionally from the elastic element. In this way, it is possible to achieve advantageously higher spring forces on the one hand by using materials or designs for the elastic element having greater spring rigidity as compared to conventional latching lances. At the same time, a significantly greater area between the contact latching element and the contact carrier latching surface is provided than in the case of a simply designed free end of a latching lance-like latching element, as a result of which higher retention forces may be achieved without damaging the contact latching element. In addition, the functional and/or spatial decoupling of elastic element and contact latching element may reduce the mechanical load at a base of a conventional latching lance, i.e., at the point at which the latching lance is connected to the contact. This is because, according to the present invention, no force, or only minimal force (for example, maximally 10%, preferably maximally 5% of the extraction force), acts on the elastic element along the plug-in direction. This may be effectuated, for example, by the shape of the second inner wall and of the elastic element. If, for example, the contact surface of the elastic element in the latched position is shaped in such a way that the contact surface extends generally in parallel to the plug-in direction, the elastic element may then slide along this parallel contact surface without jamming when the contact is unplugged from the contact carrier. This reduces the intermittent mechanical stress on the material. In this way, a rupture of the elastic element on the contact at the base of the elastic element is prevented. In addition, a burying of a free end of the elastic element into the contact carrier is advantageously prevented. In addition, a burying of an edge of a recess of the contact, in which an elastic element of the contact carrier engages, into the elastic element situated on the contact carrier is prevented. Thus, an elaborate secondary locking or secondary locking slider advantageously also becomes unnecessary without sacrificing quality. In conventional plug connector assemblies, a secondary locking slider introducible transversely to the plug-in direction is often inserted into the contact carrier when the contacts are primarily latched in the contact carrier. With this generally separate and, therefore, elaborate and expensive secondary locking slider, the relatively weak latching lances used as primary latching elements are secured against damage as a result of excessive extraction forces.

The contact may also be advantageously formed as a stamped bent part and in this way be manufactured in a particularly cost-effective and simple manner.

The contact may be further advantageously manufactured from a thin metal sheet having a material thickness, which is between 0.1 mm and 0.5 mm, preferably between 0.12 mm and 0.2 mm. Contacts of this type are suitable, for example, for transmitting electrical signals, for example, in automobile control units and may, for example, be ideally used in multi-pole plug connector assemblies with little available space. With the configuration according to the present invention, a high primary retention force of the contact thus formed is possible in the contact carrier, even with such minimal material thicknesses, without the need for a separate and, therefore, elaborate, expensive and complicated secondary locking.

A rear contact end section is also advantageously formed as an immovable contact latching element at the transition from the contact section to the neck section, for example, as an end on the side of the neck section of a contact box of the contact housing formed in the contact section, which results in a particularly large contact surface between the contact latching element and the contact carrier latching surface, when the attempt is made to unplug the contact from the contact carrier.

The rear contact end section is also advantageously designed flat, particularly advantageously as a planar surface. As a result, a force which is applied to the contact when attempting to unplug the contact from the contact carrier, is distributed over a particularly large and planar surface of the contact latching element in mechanical contact with the contact carrier latching surface. This advantageously reduces the mechanical stress in the form of a pressure or linear pressure on individual sections of the contact or of the contact carrier. This increases the primary retention force of the contact in the contact carrier to a point at which the contact or contact carrier may be stressed without damage.

In one refinement of the present invention, it is provided that the protrusion includes a first height h1 in the direction of the spring force of the at least one elastic element. In this case, the at least one elastic element is designed to raise the contact in the inserted state in the contact carrier transversely to the plug-in direction by at least 30% of the first height h1, in particular, by at least 80% of the first height h1 in relation to the second inner wall, and in this way push it into the latched position and hold it there. The advantageous effect of this is that a significant portion of the protrusion contributes to the formation of the contact surface between the contact latching element and the contact carrier latching surface and, in this way, a qualitatively superior latching, i.e., a reliable latching with a high force is achieved. This also advantageously prevents an accidental loosening of the latching.

The advantageous effect of the at least one elastic element provided on a side of the contact or contact housing opposite the protrusion is that the functional separation between the elastic element as an element for moving the contact in a direction transverse to the plug-in direction, and the contact latching element as an element for absorbing an extraction force counter to the plug-in direction may be implemented in a particularly simple, reliable, robust and stable manner. This is because the elastic element, which acts generally in a direction transverse to the plug-in direction, is barely stressed when a force acts on the contact element opposite the plug-in direction, since this extraction force is virtually completely absorbed as a result by the contact latching element being separated functionally and spatially completely from the elastic element. As a result, the contact may be particularly simply and cost-effectively manufactured, because the elastic element may be considered completely independently of the contact latching element.

When designing material thicknesses, spring constants or the like for the functionally relevant parameters, and therefore it is not necessary to accept a compromise between the two functions, preferably elastic resilience on the one hand and high primary retention force on the other hand.

One refinement of the present invention provides that the at least one elastic element is fastened on or in the contact, in particular, on or in the contact section or on or in the contact box of the contact. The advantageous effect of this is that the same contact carrier may be used for the contact, despite the modified latching design. This may avoid having to manufacture a new contact carrier for the contact. In this way, the contact may be further advantageously manufactured in a particularly low-cost and simple manner, because only one elastic element, which is suitable for moving the contact transversely to the plug-in direction and holding it, is to be fastened on or in the contact.

One refinement of the present invention provides that the at least one elastic element is designed in such a way that a free end of the at least one elastic element does not project beyond the outer contour of the contact. The advantageous effect of this is that a free end of the elastic element cannot jam in the material of the contact carrier when plugging the contact into the contact carrier in the plug-in direction, or when unplugging the contact from the contact carrier in a direction opposite the plug-in direction. In addition, this advantageously also effectively reduces the risk of jamming of individual contacts to cables or of individual contacts among one another and damage resulting therefrom, for example, during transport to a cable manufacturer or during the assembly process.

Designing the contact and the at least one elastic element in one piece, enables a particularly simple and cost-effective manufacture of the contact and of the plug connector assembly. The contact with the at least one elastic element may be particularly advantageously manufactured from a metal sheet, for example, as a stamped bent part.

One refinement of the present invention provides that the at least one elastic element is situated on the second inner wall of the chamber of the contact carrier. The advantageous effect of this is that no filigree elastic part in the form of the elastic element has to be provided on the contact, as a result of which the risk of damage to the elastic element during transport or during handling of the contact is sharply reduced. In the case of miniaturized contacts, for example, a stronger resilience may be advantageously achievable in a simple and cost-effective manner by situating the elastic element in the contact carrier than would be possible by forming the elastic element on the contact. So-called clean body contacts, in which no elements project from the body of the contact or from the outer contour of the contact, may also be advantageously manufactured in this way. The elastic element may be advantageously situated in the contact carrier as a highly elastic spring made of spring steel.

Because at least part of the second inner wall of the chamber is designed as an elastic element, the elastic element may be formed on the contact carrier in a particularly simple and cost effective manner. This provides a particularly cost-effective plug connector assembly. The elastic element may be advantageously formed, for example, as an injection molded part from the inner wall of the chamber.

### BRIEF DESCRIPTION OF THE DRAWINGS

Additional features and advantages of the present invention will become apparent to those skilled in the art from the following description of exemplary specific embodiments with reference to the figures, which, however, are not to be interpreted as limiting the present invention.

FIG. 1 shows a cross section of a plug connector assembly according to the related art.

FIGS. 2a through 2c show cross sections of an example plug connector assembly according to the present invention in various states during the insertion process of a contact according to the present invention into a contact carrier.

FIGS. 3a and 3b show the unlocking process of a contact according to the present invention from a plug connector assembly according to the present invention with a disassembly tool or with a disassembly tool and an auxiliary tool.

FIG. 4 shows a contact element according to the present invention having an elastic element, the free end of which lies within the outer contour of the contact.

FIGS. 5a and 5b show various states during the insertion process of a contact into the contact carrier of a plug connector assembly according to the present invention, in which the elastic element is situated on the contact carrier.

FIGS. 6a and 6b show a top view of the contact latching element from FIG. 2a facing in a direction opposite the plug-in direction, in various specific embodiments.

All figures are merely schematic representations of devices according to the present invention, or their components according to exemplary embodiments of the present invention. Distances and size relations, in particular, are not shown to scale in the figures. Corresponding elements in the various figures are provided with the same reference numerals.

### DETAILED DESCRIPTION OF EXAMPLE EMBODIMENTS

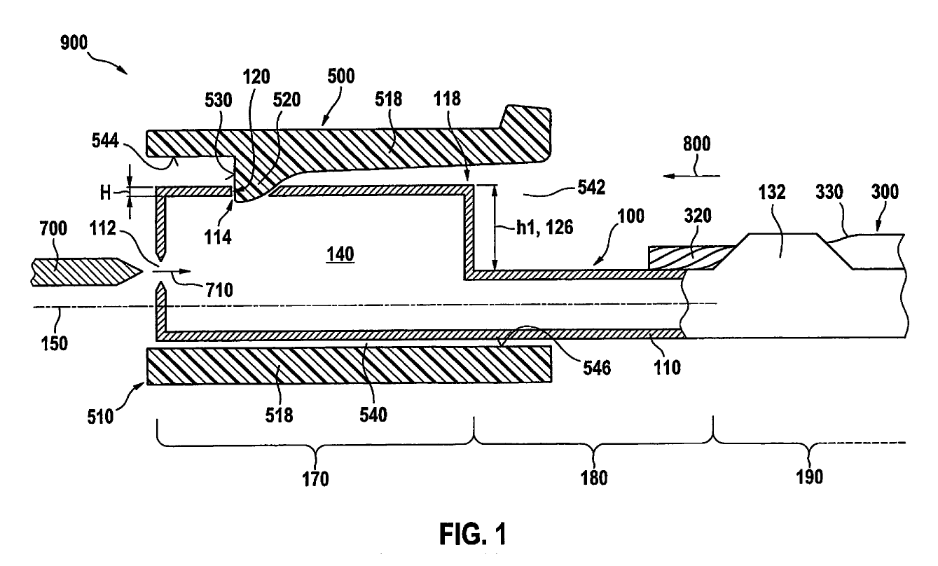

FIG. 1 shows a cross section of a plug connector assembly 900 according to the related art. The plug connector assembly 900 for establishing an electrical plug connection includes a contact carrier 500 and a contact 100 having a contact housing 110.

The contact carrier 500 includes a contact carrier housing 510 having a chamber 540 for receiving a contact section 170 or a contact box of contact 100 formed in contact section 170. Chamber 540 is enclosed by a chamber wall 518. It includes a first inner wall 544 generally in parallel to plug-in direction 800, an elastic contact carrier latching element 520 adjacent to first inner wall 544 designed generally transversely to plug-in direction 800, which includes a contact carrier latching surface 530, as well as a second inner wall 546 opposite first inner wall 544. First inner wall 544 and second inner wall 546 face an interior 542 of chamber 540.

Contact 100 is insertable in a plug-in direction 800 into contact carrier 500. Contact 100 extends along a longitudinal axis 150 and includes, besides contact section 170, a connecting neck section 180 and a fastening section 190 connected to the neck section 180. A cable 300 having a cable insulation 330 and electrically conductive strands 320 is fastened to fastening section 190 with the aid of a crimp lug 132. Contact 100 includes a contact opening 112 in its contact housing 110 at the end opposite cable 300, through which a mating contact 700 may be plugged in in a mating contact plug-in direction 710 into an interior 140 of contact housing 110, in order in this way to establish an electrical contact between mating contact 700 and contact 100. Contact housing 110 in this case is designed as a contact box in contact section 170, for example, with a hollow-bodied cross section for receiving mating contact 700. Contact section 170 includes a protrusion 126 relative to the neck section 180 transverse to the longitudinal axis 150, having a first height h1.

Contact section 170 and contact box, which is situated or formed in contact section 170, includes a latch opening 114, an end surface of the opening facing in a direction opposite plug-in direction 800 and used as a contact latching element 120. Contact latching element 120 is immovable relative to contact section 170. Contact latching element 120 and contact carrier latching surface 530 are designed in such a way that in a latched position of contact 100 inserted into contact carrier 500, contact carrier latching element 520 engages behind contact latching element 120. Thus, contact latching element 120 is limited to a surface, which is the result of the length of the opening transverse to the depicted image surface on the one hand and of the thickness H of the material thickness of the contact housing transverse to plug-in direction 800 on the other hand. The latch opening 114 is normally produced by a punching process, as a result of which contact latching element 120 may be sharp-edged. Thus, with a pull on the cable in a direction opposite plug-in direction 800, contact 100 is latched in contact carrier 500. However, a high pressure is produced as a result of the small contact surface between contact latching element 120 and contact carrier latching element 520, which a contact carrier latching element 520 manufactured from plastic cannot readily withstand and may be damaged as a result of the contact 100 burying itself into its material. Alternatively, in the case of a thin material thickness H of contact housing 110, contact latching element 120 may be damaged by the area around latch opening 114 folding if too much force is applied, and contact 100 is then damaged as a result.

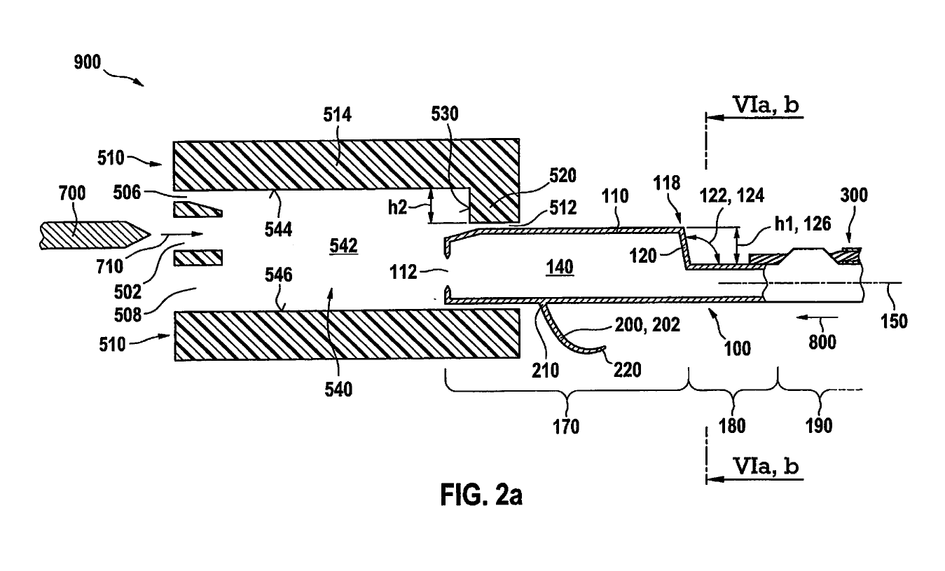

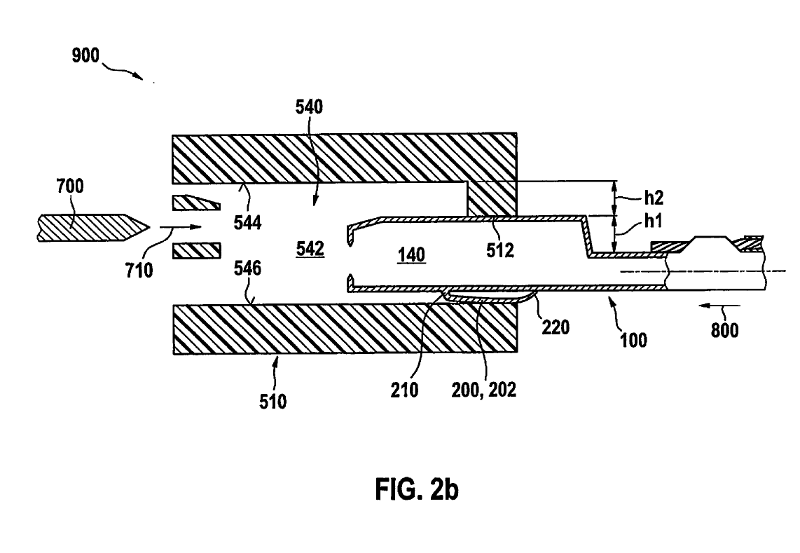

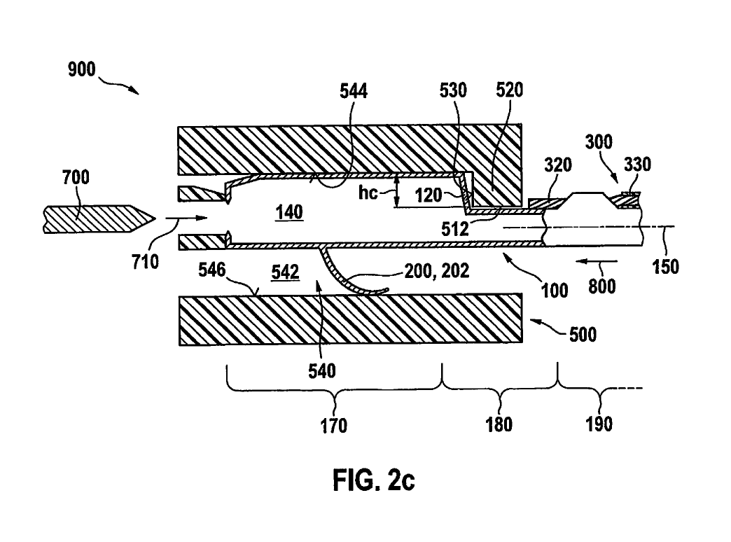

FIG. 2a shows a neutral position of the plug connector assembly according to the present invention. Contact 100 in this case is in a position, in which it has not yet been inserted into contact carrier housing 510. Contact carrier housing 510 includes a plug-in opening 512 on its side of chamber 540 facing contact 100 for inserting contact 100. Chamber 540 widens behind plug-in opening 512. This widening occurs behind a rigid projection, which delimits plug-in opening 512 laterally transverse to plug-in direction 800, and which functions as contact carrier latching element 520. Contact carrier latching element 520 has a second height h2 transverse to plug-in direction 800 opposite first inner wall 544. Contact carrier latching element 520 is designed in the manner of an undercut edge. Contact carrier 500 also includes in contact housing 510 a disassembly tool opening 506 on its side opposite plug-in direction 800 adjacent to first inner wall 544, and an auxiliary tool opening 508 adjacent to second inner wall 546. Contact carrier housing 510 also includes a mating contact opening 502 between disassembly tool opening 506 and auxiliary tool opening 508, through which a mating contact 700 may be inserted in order in this way to be able to electrically connect with contact 100 plugged into chamber 540 (cf. FIG. 2c).

Contact 100 includes a rear contact end section 118 at the transition from contact section 170 to neck section 180. This transition arises at the end of contact housing 110 formed in contact section 170 as a contact box. The contact box has a hollow chamber-like design so that a mating contact may be plugged into it opposite plug-in direction 800. The transition from contact section 170 to neck section 180 in this case is designed as contact latching element 120, contact latching element 120 including a protrusion 126 with first height h1 as the difference between an upper surface of contact section 170 and an upper surface of neck section 180. The surface of contact latching element 120 merges at a transition angle 122 into neck section 180, transition angle 122 preferably being between 70° and 100° and particularly preferably designed as a right angle 124. Contact 100 preferably includes at least one elastic element 200, 202 on the side opposite protrusion 126 on contact section 170 or in the area between contact section 170 and neck section 180. In the exemplary embodiment depicted, elastic element 200, 202 is fastened on an outer side of the contact box, which represents the housing portion of contact housing 110 in contact section 170, and projects outwardly from the contact box. Elastic element 200, 202 is elastically reversibly deflectable in a direction transverse to longitudinal axis 150 of contact 100. Elastic element 200 depicted herein is designed as a leaf spring and has a base 210 and a free end 220. In the neutral position of elastic element 200, the largest cross section of contact section 170 is larger than the cross section of plug-in opening 512 for contact 100 in contact carrier housing 510. Thus, when plugging contact 100 into contact carrier housing 510, elastic element must be pushed elastically reversibly inward, i.e., transversely to longitudinal axis 150 to interior 140 of contact housing 110, so that contact 100 may be shifted or inserted through plug-in opening 512 of contact carrier 500 into chamber 540 of contact carrier 500. In this state, contact 100 with elastic element 200, 202 is in a neutral position.

FIG. 2b shows an insertion state of contact 100 during the plug-in process, in which elastic element 200, 202 on contact 100 is pushed inward, in order in this way to be able to insert contact 100 through plug-in opening 512 in contact carrier housing 510 into interior 542 of chamber 540. In the process, elastic element 200, 202 is supported on second inner wall 546. In this state, contact 100 is situated with its elastic element 200, 202 in an insertion position differing from the neutral position.

FIG. 2c shows a latched state or locked state: contact 100 with its contact section 170 is inserted completely into chamber 540 and has been moved into a latched position by elastic element 200, 202. Once contact section 170 with its protrusion 126 has passed completely through plug-in opening 512 of contact carrier 500, elastic element 200, 202 in this case springs outward, i.e., transversely from longitudinal axis 150 away from contact 100. Elastic element 200, 202 is supported for this purpose on second inner wall 546 and raises contact 100 transversely to plug-in direction 800 in the direction of first inner wall 544 and thereby pushes it and holds it in the latched position. In this way, contact latching element 120 with its protrusion 126 is engaged in a form-locked manner from behind by contact carrier latching element 520. Elastic element 200, 202 in the depicted latched position is located on a contact surface on second inner wall 546 (this is the point in the figure at which elastic element 200, 202 is in mechanical contact with second inner wall 546). This contact surface is generally in parallel to plug-in direction 800. Thus, contact 100 is latched or locked in contact carrier 500 against an unplugging of contact 100 from contact carrier 500.

If, for example, cable 300 of contact 100 is pulled opposite plug-in direction 800, contact latching element 120 comes into mechanical contact with contact carrier latching surface 530. In other words, in the depicted exemplary embodiment, the end of the contact box abuts contact carrier latching surface 530. Contact latching element 120 is therefore formed by the end of the contact box facing neck section 180. Contact latching element 120 is therefore an integral part of the contact box and does not project beyond the outer contour of the contact box. The result is a contact surface between the two latching elements 120, 520, which has a height hc transverse to the plug-in direction, which corresponds maximally to first height h1 of protrusion 126, or maximally to second height h2 of the undercut edge of contact carrier latching element 520. To prevent contact 100 from wobbling in contact carrier 500 and, at the same time, to achieve a particularly effective, i.e., particularly large contact surface, height hc of the contact surface has at least 30%, preferably at least 80% of first height h1 transverse to plug-in direction 800. In this way, the housing wall of contact 100 facing first inner wall 544 is in mechanical contact with first inner wall 544. The contact surface effective against an unplugging between contact latching element 120 and contact carrier latching surface 530 is significantly increased in this manner compared to the effective contact surface in the related art from FIG. 1.

In addition, elastic element 200, 202 has to absorb only little force or no force at all along or opposite plug-in direction 800, preferably less than 20% of the force, particularly preferably less than 10% of the force and more particularly preferably less than 5% of the force. It absorbs barely any or no force, since it slides on the contact surface in parallel to the plug-in direction across second inner wall 546 and, unlike contact latching element 120, is not latched or locked in a form-locked manner with contact carrier 500. Thus, elastic element 200 may be fully optimized toward applying a preferably reliable, permanent and large elastic force transversely or perpendicular to plug-in direction 800, in order in this way to initially push or lift contact 100 or contact box of contact 100 into the latched position and to hold it in the state inserted in contact carrier 500 with the aid of the spring action. In this way, the already existing transition from contact section 170 to neck section 180 may be used as contact latching element 120. This contact latching element 120, having no special structural design, is stable compared to conventional latching lances to the point that even a sensitive, elaborate and expensive secondary locking element or a secondary locking slider for safely locking the contact in the contact carrier, may be advantageously dispensed with. The outer contours of contact 100 are also barely modified compared to conventional contacts, so that even the same contact carriers 500 may be used, which saves significant costs. In other words, contact 100 according to the present invention is a contact 100 compatible with conventional contact configurations and, at the same time, significantly more robust.

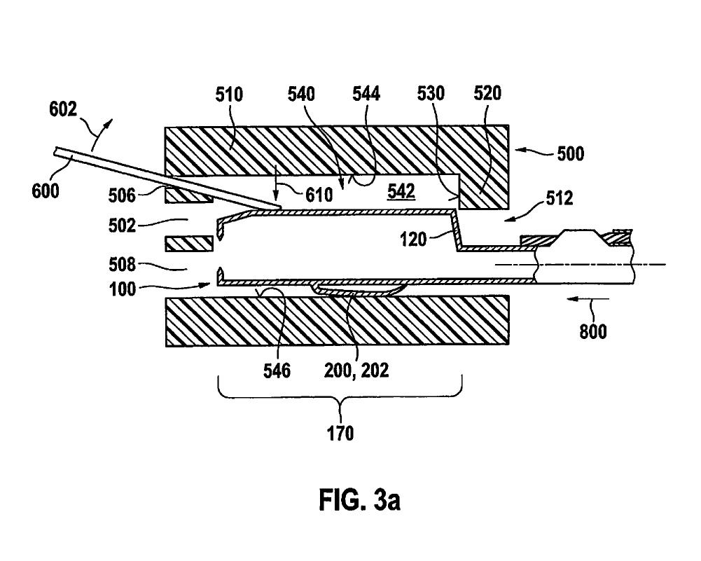

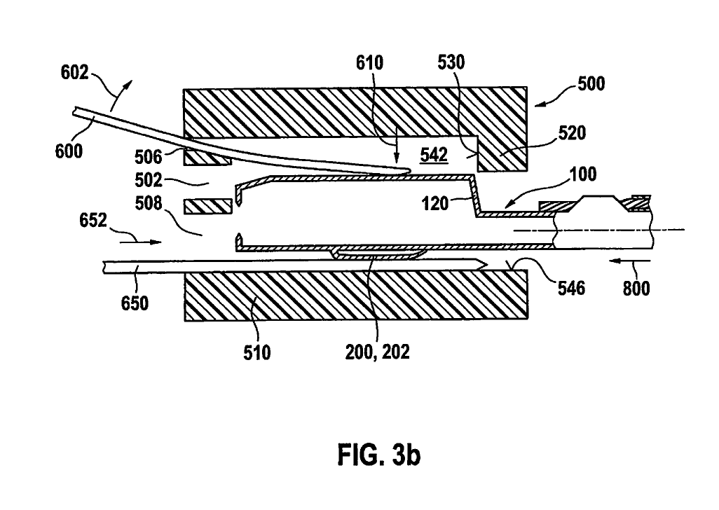

FIG. 3a depicts in cross section how the contact depicted from FIGS. 2a through 2c may be removed from chamber 540 of contact carrier 500 with the aid of a disassembly tool 600. For this purpose, an assembler introduces mandrel-like disassembly tool 600 through disassembly tool opening 506 and sticks it between first inner wall 544 and contact 100. With a movement of disassembly tool 600 transverse to plug-in direction 800 upward in the drawing according to arrow 602, the tip of mandrel-like disassembly tool 600 situated in interior 542 of chamber 540 is pushed in the direction of arrow 610 and thereby presses contact 100 in the direction of second inner wall 546. In the process, elastic element 200, 202 is also compressed and contact latching element 120 may be released from the form-locked connection with contact carrier latching element 520. In addition, the cross section of contact section 170, together with elastic element 200, 202, may be reduced to the point that it becomes smaller than the cross section of plug-in direction 512, as a result of which contact 100 may be removed damage-free from contact carrier 500, for example, by carefully pulling on cable 300.

FIG. 3b depicts a further disassembly option for the contact from FIGS. 2a through 2c. For this purpose, an auxiliary tool 650, in addition to disassembly tool 600, is introduced through auxiliary tool opening 508 of contact carrier housing 510 generally opposite plug-in direction 546 along arrow 652, and inserted between second inner wall 546 and elastic element 200, 202. With the aid of auxiliary tool 650, elastic element 200, 202 may be more easily moved inward to contact 100, which may facilitate the unplugging process of contact 100 from contact carrier 500.

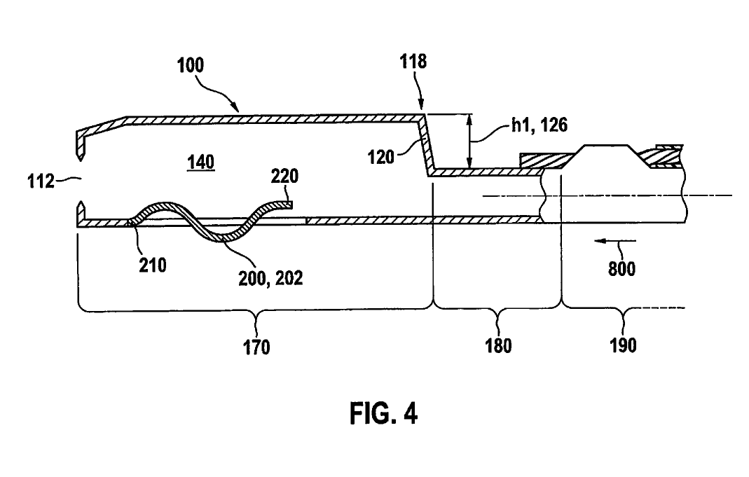

FIG. 4 shows another exemplary embodiment of a contact 100 according to the present invention. This contact 100 may be considered to be a clean body contact. In this case, elastic element 200 is designed as a leaf spring 202. It includes a base 210, i.e., a fastening point of leaf spring 202 on contact section 170 or on the contact box of the contact housing, and a free end 220, which extends opposite plug-in direction 800 in the exemplary embodiment. Elastic element 200 in this configuration is designed in such a way that free end 220 ends in interior 140 of contact 100 or in interior 140 of the contact box, and at least at no point projects beyond the outer contour of contact 100. This advantageously prevents the free end from jamming on other contacts or cables or parts of contact carrier 500. Alternatively, elastic element 200 may, of course, also be designed in a manner different from a leaf spring 202. More generally, it is irrelevant in the case of contacts 100 according to the present invention whether elastic element 200 with its free end 220 extends in the direction of plug-in direction 800 or opposite plug-in direction 800. Thus, in another example, free end 220 in FIG. 4 could, for example, point to the left and the base 210 could be situated to the right of free end 220 in FIG. 4. This is due to the fact that elastic element 200, 202 of contact 100 according to the present invention does not have to absorb any retention forces along or opposite plug-in direction 800, but rather is merely designed in such a way that in the inserted state of contact 100 into contact carrier 500 it pushes contact 100 away from second inner wall 546 into its latched position and holds it there. For this purpose, contact 100 is raised relative to second inner wall 546, i.e., moved translationally. That elastic element 200, 202 absorbs barely any or no force against plug-in direction 800, is due to the fact that here the contact surface of elastic element 200, 202, for example, on second inner wall 546, is generally in parallel to plug-in direction 800.

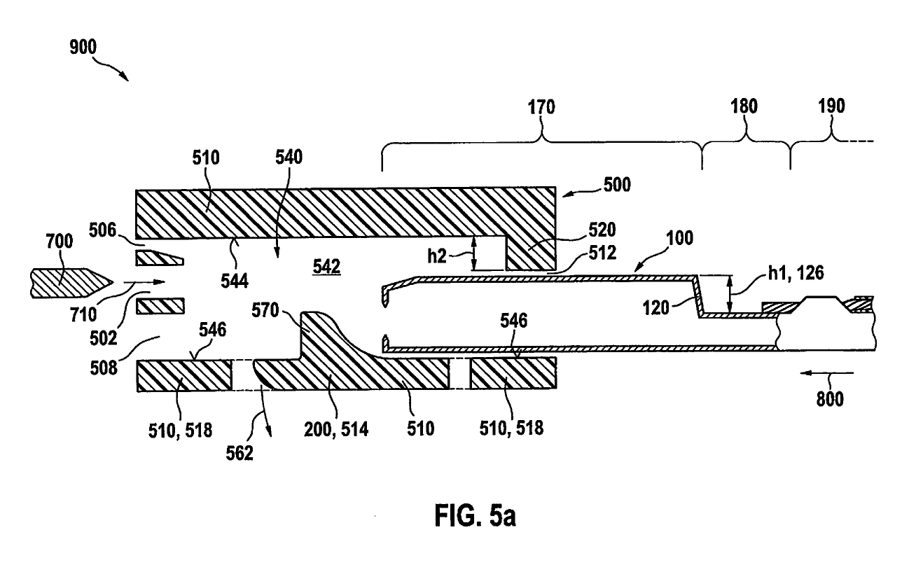

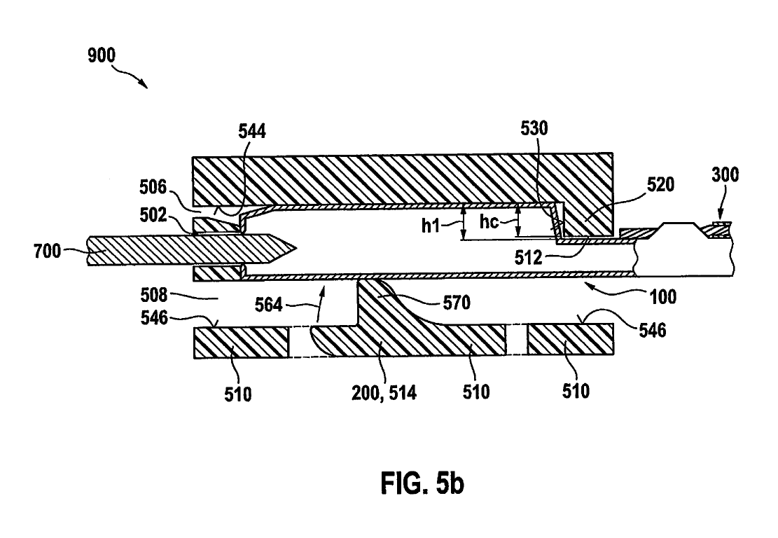

FIGS. 5a and 5b depict another specific embodiment of a plug connector assembly 900 according to the present invention. In this assembly, contact 100 is modified as compared to the contacts from FIGS. 2 through 4 only to the extent that it includes no elastic element 200, 202. In contrast to the related art depicted in FIG. 1, however, contact 100 also includes no latch opening 114. In this exemplary embodiment as well, contact latching element 120 formed at the transition from contact section 170 to neck section 180, i.e., the end of the contact box on the side of the neck section in the form of protrusion 126, is engaged in a form-locked manner in the latched position by contact carrier latching element 520. However, elastic element 200, 514, which pushes contact 100 in the state where it is inserted into contact carrier 500 away from second inner wall 546 transversely to plug-in direction 800 into its latched position and holds it there, is formed by an elastically designed portion of inner wall 546. This elastic element 200, 514 is able to move elastically reversibly transverse to plug-in direction 800 downward in the figure along arrow 562, when contact 100 is plugged into contact carrier 500 and abuts a ramp-shaped inwardly projecting protrusion 570 of elastic element 200. Once contact 100 with its contact box situated in contact section 170 has passed plug-in opening 512, elastic element 200, 514 springs inward along arrow 564 as shown in FIG. 5b, i.e., in the direction of interior 542 of chamber 540. As a result, it raises contact 100 and the contact box of contact housing 110 situated in contact section 170 relative to second inner wall 546 and pushes contact 100 into its latched position and holds it there.

In the depicted exemplary embodiment, elastic element 200, 514 is not connected to chamber wall 518 of contact carrier housing 510 in the depicted sectional plane. The attachment in this case takes place outside the image plane, for example, laterally at an end of elastic element 200, 514 facing plug-in opening 512 of contact 100. In the figure, it is indicated with dashed lines that the chamber wall continues behind elastic element 200, 514. In other specific embodiments, however, elastic element 200, 514 may also be connected to chamber wall 518, for example, on its side facing plug-in opening 512 for contact 100.

Contact carrier 500 of the exemplary embodiment depicted herein resembles somewhat contact carrier 500 of FIG. 1 from the related art. The main difference to be noted, however, is that elastic element 200 in contact carrier 500 according to the present invention of FIGS. 5a and 5b does not have to absorb any forces along or opposite plug-in direction 800 when an extraction force, for example, by a tug on cable 300 not depicted, acts on contact 100 in the state where it is plugged into connector 500. Extraction forces of this type are absorbed exclusively via the contact surface, which is formed on the contact carrier latching element between contact latching element 120 and contact carrier latching surface 530. The fact that elastic element 200, 514 has to absorb barely any or no extraction force in plug-in direction 800 is attributed to the fact that the contact surface of elastic element 200, 514 in the latched position is generally in parallel to plug-in direction 800. The contact surface of elastic element 200, 514 is formed here on an outer wall of the contact box of contact 100 in contact section 170.

In an exemplary embodiment not depicted herein, second inner wall 546 may also be rigid and an elastic element 200 made, for example, of an elastic material such as, for example, a metal (for example, spring steel) or an elastic plastic, may be situated on second inner wall 546. In this case, contact 100 is pushed during insertion over this elastic element 200, which is elastically reversibly compressed as a result and, once its contact section 170, for example, has completely passed plug-in opening 512, raises contact 100 from second inner wall 546 toward first inner wall 544 and thus forces it into its latched position and holds it there.

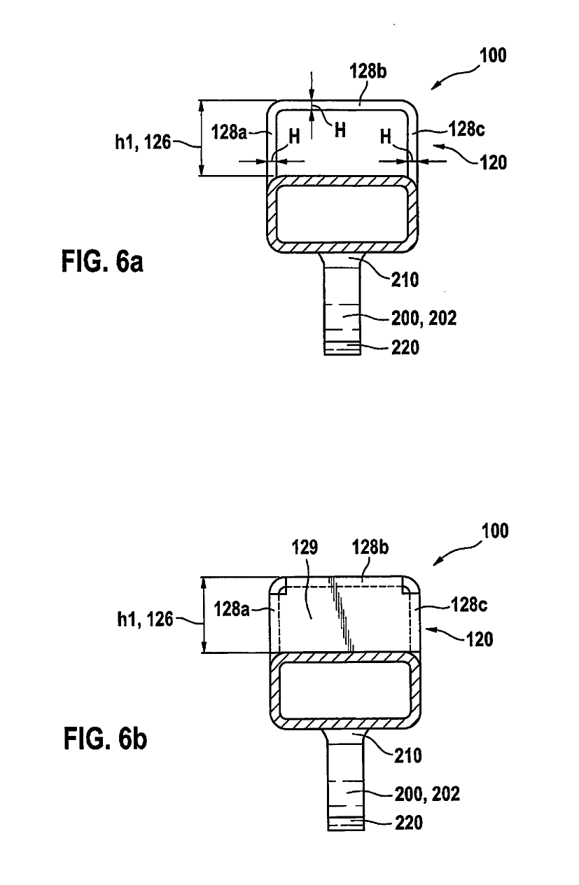

FIGS. 6a and 6b each depict a top view of contact latching element 120, which appears as a section along lines VI-a,b in FIG. 2a.

In FIG. 6a, contact 100 is designed as a stamped bent part, contact latching element 120, i.e., the end of the contact box of the contact housing facing neck section 180, being formed by the three front surfaces 128a, 128b, 128c of rectangular-shaped contact section 170. Thus, in the case of a mechanical contact with contact carrier latching surface 530, the contact surface is thus that surface of front faces 128a, 128b, 128c, which come into mechanical contact with contact carrier latching surface 530. As a result of front surfaces 128a, 128b, 128c, each bent by approximately 90° relative to one another, their rigid, i.e., in particular non-elastic design, and their longitudinal extension into the image plane, a high geometrical moment of inertia and, as a result, a high load-bearing capacity in the direction of the image plane is achieved. A significantly higher primary retention force is achieved thereby compared to conventional latching lances, which are elastically designed and which have only one single surface corresponding to front surface 128b.

FIG. 6b shows another specific embodiment of contact latching element 120. In this case, rear contact end section 118 is flat, in particular, a planar surface 129. This may be effectuated, for example, in that a flat metal strip, for example, during the stamp bending process is laid or folded across front surfaces 128a, 128b, 128c. The front surfaces support planar surface 129 opposite plug-in direction 800. In this way, a significantly larger contact surface is created between contact latching element 120 and contact carrier latching surface 530 when a force acts on contact 100 opposite plug-in direction 800. This lowers the pressure intermittently acting at individual points of the contact or of the contact carrier, as a result of which damage to contact carrier latching element 520 by contact latching element 120 may be even more effectively prevented.

In general, elastic element 200 may be designed as one piece with contact 100 or with contact carrier 500. It may, however, be manufactured initially as a separate part and then be connected to contact 100 or to contact carrier 500, for example, through adhesion, welding or a form-locking or force-locking connection. In this way, it is possible to use a material for elastic element 200, which is optimal for the spring function, whereas a particularly good electrical insulating material (for example, a plastic) may be used for contact carrier 500, and a particularly good electrically conductive material (for example, copper, copper alloy, etc.) may be used for the contact. It is, of course, also possible for one elastic element 200, 202, 514 each to be situated on contact 100 and the contact carrier. Exemplary embodiments are also possible, in which two or more elastic elements 200, 202 are situated on contact 100 and/or two or more elastic elements 200, 514 are situated on contact carrier 500.

Contacts are also possible, in which contact latching element 120 is not formed by the end of the contact box on the side of the neck section, but rather by a latching element situated on the outside of and protruding from the contact box.

The provided plug connector assembly 900 or the provided contact 100 may be designed, for example, as a socket contact, in particular, as a multi-pole plug connector assembly for socket contact connections (for example, more than 50 or even more than 120 contact chambers per plug connector). The plug connector assembly and the contact are also suitable for direct plug connectors or multipoint connectors. They are also suitable for miniaturized socket contacts or for plug connector assemblies suitable therefor, which have a sheet thickness in the range of, for example, 0.1 mm to 0.3 mm, in which latching elements projecting outward from the housing, for example, in the form of latching lances or locking catches, are unable to absorb the required high primary retention forces in the axial direction along plug-in direction 800.

Finally, it should be noted that terms, such as “having,” “including,” etc. do not rule out any other elements, and terms such as “a” do not rule out a plurality. It is also noted that features, which have been described with reference to one of the above exemplary embodiments, may also be used in combination with other features of other exemplary embodiments described above. Reference numerals in the claims are not to be viewed as limiting.

What is claimed is:

1. A plug connector assembly for establishing an electrical plug connection, comprising:
a contact carrier; and
a contact, the contact being insertable into the contact carrier in a plug-in direction, the contact extending along a longitudinal axis, the contact including a contact section and a connecting neck section, the contact section including a contact latching element which includes a protrusion relative to the neck section transverse to the longitudinal axis and is immovable in relation to the contact section, the contact carrier including a contact carrier housing having a chamber for receiving the contact section of the contact, the chamber including:
a first inner wall in parallel to the plug-in direction,
a contact carrier latching element which includes a contact carrier latching surface, and which is provided adjacent to the first inner wall transverse to the plug-in direction, and
a second inner wall opposite the first inner wall, the contact latching element and the contact carrier latching surface being designed in such a way that in a latched position of the contact inserted into the contact carrier, the contact carrier latching element engages behind the contact latching element,
wherein at least one elastic element is provided in the plug connector assembly, which is designed to push the contact in a state inserted into the contact carrier (500) away from the second inner wall transversely to the plug-in direction into the latched position and to hold it there.

2. The plug connector assembly as recited in claim 1, wherein the contact is formed as a contact box in the contact section, the contact box being designed to receive a mating contact pluggable into the plug connecter assembly in an interior of the contact box, opposite the plug-in direction.

3. The plug connector assembly as recited in claim 1, wherein the elastic element abuts a contact surface in the latched position, on the second inner wall, the contact surface extending parallel to the plug-in direction.

4. The plug connector assembly as recited in claim 1, wherein the elastic element and the contact latching element are designed in such a way that in the state of the contact situated in the latched position in the contact carrier, the elastic element absorbs no more than 10% of a force component along the plug-in direction, when the contact is acted upon by a force opposite the plug-in direction.

5. The plug connector assembly as recited in claim 4, wherein the elastic element absorbs no more that 5% of the force component.

6. The plug connector assembly as recited in claim 1, wherein the protrusion has a first height in a direction of the elastic force of the at least one elastic element, the at least one elastic element being designed to raise the contact in the state where it is inserted into the contact carrier relative to the second inner wall transversely to the plug-in direction by at least 30% of the first height, and in that way to push it into and hold it in the latched position.

7. The plug connector assembly as recited in claim 6, wherein the at least one elastic element being designed to raise the contact in the state where it is inserted into the contact carrier relative to the second inner wall transversely to the plug-in direction by at least 80% of the first height.

8. The plug connector assembly as recited in claim 1, wherein the at least one elastic element is provided on a side of the contact opposite the protrusion.

9. The plug connector assembly as recited in claim 1, wherein the at least one elastic element is fastened on or in the contact.

10. The plug connector assembly as recited in claim 1, wherein the at least one elastic element is fastened on or in the contact section of the contact.

11. The plug connector assembly as recited in claim 9, wherein the at least one elastic element is designed in such a way that a free end of the at least one elastic element does not project beyond the outer contour of the contact.

12. The plug connector assembly as recited in claim 1, wherein the contact and the at least one elastic element are designed as one piece.

13. The plug connector assembly as recited in claim 1, wherein the at least one elastic element is situated on the second inner wall of the chamber of the contact carrier.

14. The plug connector assembly as recited in claim 13, wherein at least one portion of the second inner wall of the chamber is designed as an elastic element.

15. A contact for insertion into a plug-in direction in a contact carrier of a plug-in connector assembly for establishing an electrical plug connection, the contact comprising:
a contact housing which extends along a longitudinal axis, the contact housing including a contact section and a connecting neck section, the contact section including a contact latching element, which has a protrusion relative to the neck section transverse to the longitudinal axis and is immovable in relation to the contact section, the contact latching element being designed in such a way that in a latched position of the contact inserted into the contact carrier it may be engaged behind in such a way that a removal of the contact from the contact carrier may be prevented, wherein at least one elastic element is fastened on or in the contact section of the contact housing, the at least one elastic element being designed to push the contact in a state where it is inserted into the contact carrier transversely to the plug-in direction into the latched position and to hold it there.

16. The contact as recited in claim 15, wherein the contact is formed as a contact box in the contact section, the contact box being designed to receive a mating contact pluggable into the plug connector assembly opposite the plug-in direction into an interior of the contact box.

17. The contact as recited in claim 15, wherein the elastic element and the contact latching element are designed in such a way that in the state where the contact is located in the latched position in the contact carrier, the elastic element absorbs no more than 10% of the force component along the plug-in direction, when the contact is acted upon by a force opposite the plug in direction.

18. The contact as recited in claim 17, wherein the elastic element absorbs no more than 50% of the force component.

19. The contact as recited in claim 15, wherein the at least one elastic element is provided on a side of the contact housing opposite the protrusion.
